(19) United States
(12) Patent Application Publication
(10) Pub. No.: US 2007/0024927 A1
(43) Pub. Date: Feb. 1, 2007

(54) Methods for finding and ordering photographic slides and negatives in scanners

(76) Inventors: Steven J. Simske, Fort Collins, CO (US); Scott C. Baggs, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/190,671

(22) Filed: Jul. 27, 2005

(51) Int. Cl. H04N 1/04

(52) U.S. Cl. 358/487; 358/494

(57) ABSTRACT

Disclosed are methods of refining the region boundaries for individual negatives or slides when scanning a plurality of negative or slides, including the defining of rows and columns based on the median spacings between regions, and the median spans of the regions, in the vertical and horizontal directions; and aligning the identified negative or slide regions to the defined rows and columns. The negative or slide regions may then be ordered to conform to the ordering represented on the scanning adapter.

### FIELD OF INVENTION

This invention relates generally to methods of auto-finding multiple photographic slides or negatives in a scanner.

### BACKGROUND

The use of optical scanners has become a widely-used method of capturing images for later modification in a computer, for printing, for electronic transmission, or for storage. It is now a common practice for consumers to scan photographic slides or negatives into their home computers. Many flatbed scanners include adapters that allow multiple slides or negatives to be processed in a single scan, simplifying a highly-repetitive task.

To make the process as simple and straightforward as possible, scanning firmware and software may typically include routines that attempt to automatically recognize the areas of interest on the scanning bed, and to set the scanning boundaries such that only those areas are acquired (“auto-find”), thus obviating the need to subsequently reformat or crop the acquired image. The identification of the region of interest can be a complex problem when dealing with arbitrary images, such as photographs; slides and negatives, however, provide a simpler analysis problem than photographs, since they are typically of a uniform size and are surrounded by at least some width of black boundary on two or more sides.

Using this fore-knowledge about slides and negatives, the process of finding the region to be scanned can be greatly sped up, for example, by first defining and convexing the black (sub-threshold) regions, and then forming regions from the non-black pixels within these regions. Also, since slides and negatives are typically of a well-defined size and shape, such as 35 mm by 23.3 mm, the region can be set to the correct size and shape.

A problem, however, arises when the content of the slide or negative does not permit a reliable detection of the edges, such as when the image on the slide or negative is very dark. In such situations, common auto-find routines may incorrectly identify the boundaries of these images.

Historically, scanning firmware and software has tended to provide the user with a preview pane of the scan, and has allowed the user to then modify the scan selection to correct for any errors in the automatic detection. When scanning multiple slides or negatives, however, this process becomes time consuming and frustrating for the user. Many flatbed scanners provide adapters which permit the scanning of substantially an entire roll of negatives or slides in a single scan. A user may not notice minor boundary errors in the preview pane, and would be disinclined to laboriously correct multiple errors.

It is also desirable that scanning software match the ordering of the resultant scans to the order expected by the user, such as the order indicated on the scanner adapter.

There is thus a need for methods which provide accurate and fast identification of multiple photographic slides or negatives in a scanner.

### SUMMARY

Exemplary embodiments of the invention include methods of refining the region boundaries for individual negatives or slides when scanning a plurality of negative or slides, including defining rows and columns based on the median spacings between regions, and the median spans of the regions, in the vertical and horizontal directions; and aligning the negatives or slides to the defined rows and columns.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIGS. 1(a) and 1(b) depict exemplary flatbed scanners such as may be used to scan multiple photographic negatives or slides, with FIG. 1(a) illustrating a scanner with an adapter for scanning strips of photographic negatives, and FIG. 1(b) illustrating a scanner with an adapter for scanning mounted photographic slides;

FIG. 2 depicts multiple strips of photographic negatives, and illustrates how an approximate region may be identified for each negative;

FIG. 3 depicts multiple photographic slides, and illustrates how an approximate region may be identified for each slide;

FIG. 4 is a flowchart of an exemplary embodiment; and

FIG. 5 illustrates how the previously-identified approximate regions may be refined by an embodiment of the invention for multiple strips of photographic negatives.

### DESCRIPTION OF EXEMPLARY EMBODIMENTS

Exemplary embodiments are described with respect to a flatbed scanner and 35 mm photographic negatives and slides; the invention, however, is not limited to the specifically described exemplary embodiments.

In the following specification, for purposes of explanation, specific details are set forth in order to provide an understanding of the present invention. It will be apparent to one skilled in the art, however, that the present invention may be practiced without these specific details. Reference in the specification to “one embodiment” or “an exemplary embodiment” means that a particular feature, structure, or characteristic described in connection with the embodiment is included in at least one embodiment. The appearance of the phrase “in one embodiment” in various places in the specification do not necessarily refer to the same embodiment.

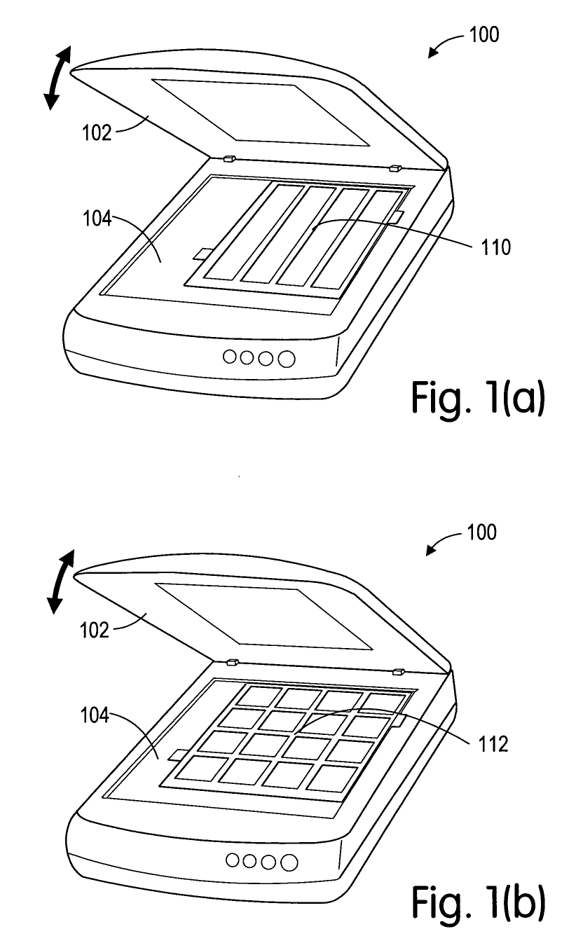

FIGS. 1(a) and 1(b) depict exemplary flatbed scanners 100 such as may be used to scan multiple photographic negatives or slides. The exemplary scanners 100 may include a hinged cover 102 which may be raised to access a scanning bed 104. The scanning bed is typically glass or other transparent material; items to be scanned are placed on the scanning bed, and a scanning element (not visible) then traverses the items from beneath the scanning bed and forms a digital representation of the items. The exemplary scanner 100 may include a negative adapter 110 (FIG. 1(a)), which positions strips of photographic negatives such that multiple negatives may be scanned “in bulk”. The scanner typically also includes processing circuitry (not visible) for executing firmware for scanning, and for communication with an external device, such as a computer or printer (not shown).

The exemplary scanner may also include a slide adapter 112 (FIG. 1(b)), which positions mounted photographic slides such that multiple slides may be scanned in bulk.

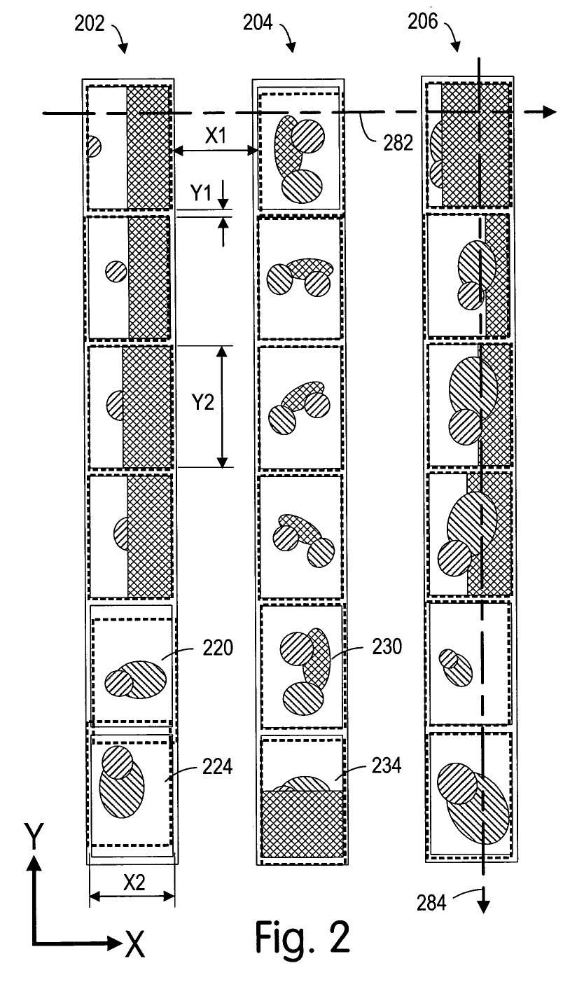

FIG. 2 illustrates multiple strips of photographic negatives as they may be positioned in a negative adapter. Typically, processed film received from a photofinisher is cut into strips of negatives 202, 204, 206; a negative adapter for a scanner is designed to position these strips for scanning.

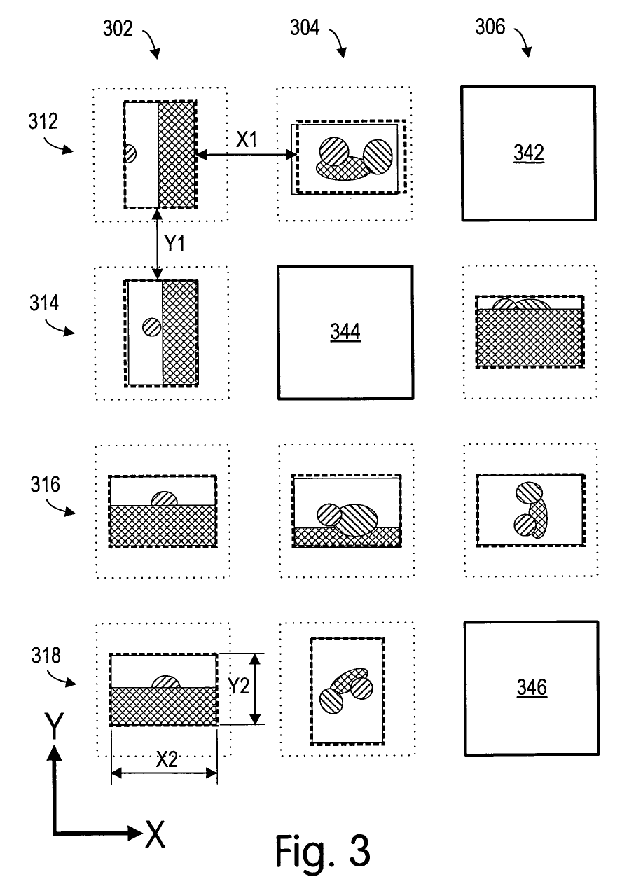

FIG. 3 depicts multiple photographic slides as they may be positioned in a slide adapter. It may be noted that individual slides may be oriented either horizontally or vertically, and that when placing the slides in an adapter, the user may choose to leave some positions unpopulated, such as indicated at 342, 344, and 346.

In scanning multiple negatives or slides, the scanning firmware or software will first define a region on the scan bed corresponding to each slide or negative; the output of the scanner will then be an individual image file of each the defined regions. Exemplary regions are indicated in FIGS. 2 and 3 by the heavy dashed lines around each negative or slide. Correctly defining the regions involves tradeoffs between the complexity of the computation, memory, and speed; a fully-automatic process is preferable to requiring user-intervention to correct errors. Exemplary methods of the invention include defining the scanning regions for multiple negatives or slides positioned in a scanner by an adapter.

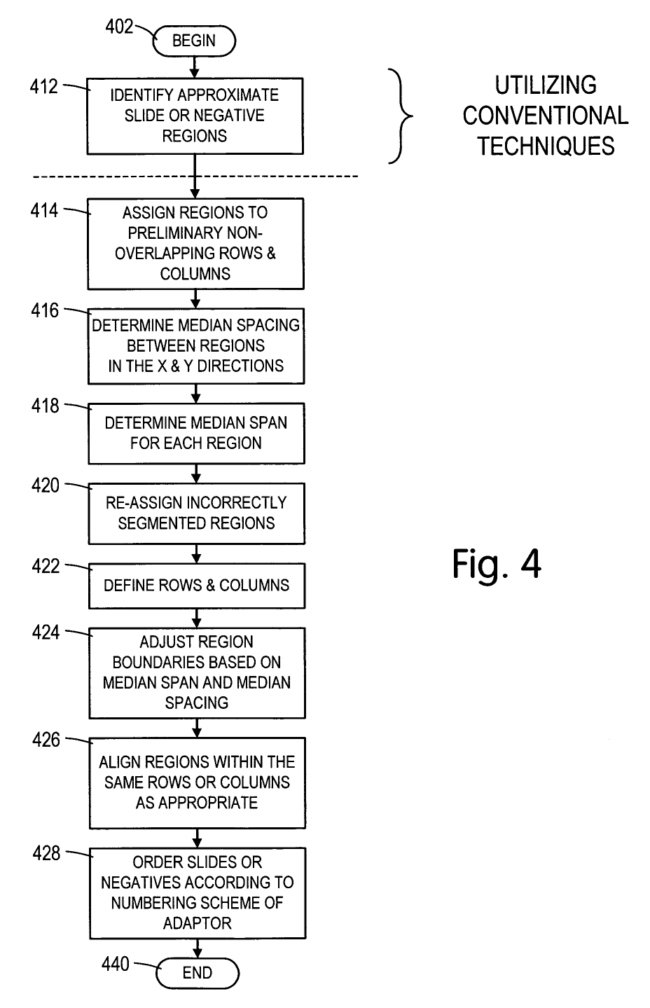

FIG. 4 is a flowchart illustrating an exemplary method. The exemplary method begins 402 by identifying approximate regions for the slides or negatives 412. Typically the scanner performs a preliminary scan at a reduced scanning resolution and analyzes the content of the scan to identify the regions corresponding to the negatives or slides. This step may utilize conventional techniques to identify the regions, such as, for example, by defining and convexing the solid regions known to lay outside and surround the slides or negatives, and then adjusting the boundaries, if necessary, where the identified region is smaller than a conventional slide or negative (a smaller region may be initially identified when some or all of the slide or negative is very dark).

Since the results of this first region identification are refined in later steps of the exemplary method, some inaccuracies may be tolerated, and the approximate region identification may be performed at a relatively lower resolution then many conventional region detection methods (e.g., embodiments of the method have been demonstrated to yield good results with 75 pixel-per-inch (ppi) data, versus the 150-400 ppi data often used by region identification methods). This reduces the memory requirements for the exemplary method and also increases processing speed.

Illustrative results for this initial region identification are shown by the heavy dashed lines in FIG. 2 for negatives, and in FIG. 3 for slides. The content of the negatives or slides may cause some incorrect region identifications, such as seen most notably at 220 and 224 in FIG. 2, where the approximate region identification method was unable to correctly find the boundary between the two negatives (for purposes of illustration, the errors illustrated in the figures may be somewhat exaggerated, and do not necessarily represent the errors resulting from any specific region identification method).

Once the preliminary regions have been identified, the regions are assigned to preliminary, or default, non-overlapping rows and columns based on at least a portion of a region falling on the same horizontal or vertical line as other regions. Thus, the top negative in each strip 202, 204, 206 (ref. FIG. 2) is assigned to the same common “row” since, when scanning across the page in the X direction, there is at least one horizontal scan line 282 that crosses each of the regions. Similarly, all the negatives in strip 206 are assigned to the same column since at least one vertical scan line 284 crosses each of these regions (and, likewise, all the negatives in strip 202 are assigned to a common column, and all the negatives in strip 204 are assigned to a column).

It may be noted that a horizontal line would cross both the lower portion of negative 220 and the upper portion negative 224. To insure that rows and columns are non-overlapping, default columns and rows are “split” if any two regions do not fall along a common scan line. Hence, although negatives 220 & 224 fall along at least one common horizontal scan line, as do negatives 220 & 230, and also negatives 224 & 234, two distinct rows are defined since regions 230 and 234 do not fall along any common scan horizontal scan. Thus, if more than two regions are assigned to a default row or column, yet any two of the regions do not fall along any common scan line (horizontal for rows, vertical for columns), the default row or column is determined to be multiple rows or columns.

Next, the exemplary method determines the median spacing between regions in both the X and Y directions. All spacings are computed between consecutive regions in these two directions, and the medians computed. As seen in FIG. 2, X1 is a representative spacing in the X direction, and Y1 is a representative spacing in the Y direction. For negatives, the lower of the two medians will define the direction of the strips of negatives, and simplify the further analysis. For slides and for the perpendicular direction of the negatives, these median values will indicate the spacing between rows and columns and help to identify “missing” sections such as those shown in FIG. 3 at 342, 344, and 346.

As used in herein, “median” may be a measure of central tendency which is not sensitive to outlying values, and is typically the value above which and below which half of the cases fall. For example, if there are 5 values, the median would be the third largest (or smallest) value. When there is an even number of values, the median may be determined to be the average of the two ‘middle’ values. “Median” as used in this specification, however, is not limited to a strict mathematical definition, but may encompass other determinations which select a central value, the selection of which is not influenced by outlying values.

The exemplary method then determines the median span for each region 418. This computation is similar to median spacing, except here the “span” is the width or the height of the individual slide or negative regions. As seen in FIG. 2, X2 is a representative span in the X direction, and Y2 is a representative span in the Y direction. For negatives, these median will tend to be similar for all columns, since negatives are placed on the scanner in parallel strips. For slides, these values will indicate (where possible) the primary orientation of a row or column. As shown in FIG. 3, though, slides can be oriented in both directions in any given row or column.

The exemplary method then re-assigns incorrectly segmented regions, or “outliers” 420. Final column and row boundaries are defined based on the median spans and median spacings determined above (thus, a new “grid” is defined based on the computed medians). Outliers are regions incorrectly segmented with respect to this new grid, and this re-assignment puts them in “alignment” with the best row and/or column to use in later correction. Outlier re-assignment is therefore done based on best alignment with a newly-defined column or row (which may, for example, be determined by how close the center of the region is to a newly-defined column or row, which may be determined by the mean X and mean Y values for the region).

Now the rows and columns for each region are defined 422, with each region being given a (column, row) index. Regions sharing the same (column, row) are either merged or one of them assigned to a nearby open (column, row) location, if appropriate (for example, if a region is “missing” where one would normally be expected, such as in a strip of negatives).

The boundaries for each region are then adjusted based on the median span and median spacing 424. For negatives, columns are scanned independently for their median spacing and span (this is because the columns need not align perfectly from one strip to the next). A simultaneously optimum start point, spacing and span is determined from best score with the regions in the column, and the regions redefined to form this column. The score is based on how far the putative column of regions is from the actual regions that are present in the column. An optimum is found so long as the majority of regions (50% or more as majority in the decision engine of the exemplary embodiment) have a correct start/stop, and so this approach will often correct segmentation errors due to very dark or overexposed negatives.

For slides, regions in each row/column are assigned to vertical/horizontal oriented bins and if possible compared to the appropriate ones to left, right, above or below to find median start/end of the region. Anomalous regions are then aligned in the next step.

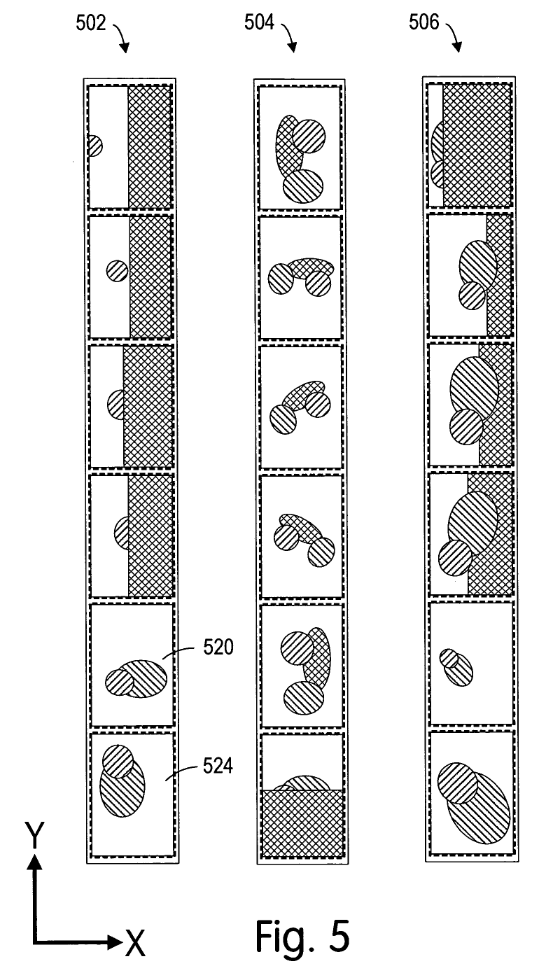

Adjusting the boundaries for each region based on the median span and median spacing adds considerable robustness to the overall finding technique. Using the median spans and spacings as a guideline and then refining the segmentation at this step allows the exemplary method to benefit from repeated patterns across columns, while adjusting the region boundaries local to each column. This way, if a single column includes segmentation errors, the neighboring columns can be used to correct the errors (compare, for example, 220/224 in FIG. 2 and 520/524 in FIG. 5).

Next regions in the same rows and columns, where appropriate, are aligned 426 such that the following occur:

Columns: vertically-oriented regions should be 35 mm wide and 23.3 mm tall, with the xmin and xmax values of this set in alignment. Horizontally-oriented regions should be 23.3 mm wide and 35 mm tall, with the xmin and xmax values of this set in alignment.

Rows: vertically-oriented regions should be 35 mm wide and 23.3 mm tall, with the ymin and ymax values of this set in alignment. Horizontally-oriented regions should be 23.3 mm wide and 35 mm tall, with the ymin and ymax values of this set in alignment.

Finally, the regions are ordered to match the numbering scheme on the slide or negative adapter 428. Table 1 is exemplary code of an embodiment for ordering negatives. Slides (code not shown) may typically be organized in reading order, while negatives may typically be organized in columnar order, such as per the code below (for slides, the x and y referents may simply be swapped out in the code):

TABLE 1

| int | i = 0; |
|---|---|
| int | j = 0; |
| int | xmax = 0; |
| int | min_x = m_Bitmap_Width; |
| int | min_y = m_Bitmap_Height; |
| int | index_min_x = 0; |
| int | index_min_y = 0; |
| bool | newOrderingFound = true; |
| int | *Order = NULL; |
| int | current_order = 0; |
| bool | *Active = NULL; |
| bool | foundActive = true; |
| RegionPolygon *rp = NULL; | |
| int | temp = 0; |

if( m_number_of_polygon_regions < 1 )

return( 0 );

Order = NEW_INT( m_number_of_polygon_regions );
if( Order == NULL )

return( NO_MEMORY );

for( i=0; i<m_number_of_polygon_regions; i++ )

Order [i]= −1;

Active = new bool [ m_number_of_polygon_regions ];
if( Active == NULL )

return( NO_MEMORY );

for( i=0; i<m_number_of_polygon_regions; i++ )

Active[i] = false;

while( newOrderingFound == true )
{

min_x = m_Bitmap_Width;
min_y = m_Bitmap_Height;
newOrderingFound = false;
for( i=0; i<m_number_of_polygon_regions; i++ )
{

if( Order[i] >= 0

continue;

if( m_list_of_polygon_regions[i]−>m_BBox_xmin < min_x )
{

min_x = m_list_of_polygon_regions[i] −>m_BBox_xmin;
index_min_x = i;
newOrderingFound = true;

}

}
for( i=0; i<m_number_of_polygon_regions; i++ )
{

if( Order[i] >= 0

continue;

if( m_list_of_polygon_regions[i] −>m_BBox_ymin < min_y )
{

min_y = m_list_of_polygon_regions[i] −>m_BBox_ymin;
index_min_y = i;

}

}
if( newOrderingFound == true )
{

if( index_min_x == index_min_y )
{

Order [index_min_x] = current_order;
current_order++;

}
else
{

// Use Active []
Active [index_min_x] = true;
xmax = m_list_of_polygon_regions [index_min_x] −>m_BBox_xmax;
for( j=0; j<m_number_of_polygon_regions; j++ )
{

if( Order[j] >= 0 )

continue;

else if( j == index_min_x )

continue;

else if( m_list_of_polygon_regions [j] −>m_BBox_xmin >= xmax )

continue;
else

Active[j] = true;

}
foundActive = true;
while( foundActive == true )
{

foundActive = false;
min_y = m_Bitmap_Height;
for( j=0; j<m_number_of_polygon_regions; j++ )
{

if( Active[j] == true )
{

foundActive = true;
if( m_list_of_polygon_regions[j] −>m_BBox_ymin < min_y )
{

min_y = m_list_of_polygon_regions[j] −>m_BBox_ymin;
index_min_y = j;

}

}

}
if( foundActive == true )
{

Order [index_min_y] = current_order;
current_order++;
Active [index_min_y] = false;

}

}
for( j=0; j<m_number_of_polygon_regions; j++ )

Active[j] = false;

}

}

}
// ***** Now rearrange the regions . . .
for( i=0; i<m_number_of_polygon_regions; i++ )
{

current_order = i;
for( j=0; j<m_number_of_polygon_regions; j++ )
{

if( Order[j] == current_order )
{

rp = m_list_of_polygon_regions[j];
m_list_of_polygon_regions[j] =

m_list_of_polygon_regions [current_order];

m_list_of_polygon_regions [current_order] = rp;
temp = Order [j];
Order[j] = Order [current_order];
Order [current_order] = temp;
break;

}

}

}
if( Order != NULL )
{

DELETE_INT( Order );
Order = NULL;

}
if( Active != NULL )
{

delete [] Active;

Active = NULL;

}

The exemplary methods thus take into account the repetitive nature of slide/negative scanning, accounting for the columns of negatives and the alignment across rows and columns for either type of scanned regions. The methods further provide a scan-to-storage motif for an entire roll of film negatives at a single time. The methods also handle an assortment of slide orientations and blanks as shown in FIG. 3.

The redefinition of the regions is also extremely fast (using region boundaries versus the raw pixel data is generally several orders of magnitude faster) and robust, in that only the majority of regions need to be correct on one or more boundary to result in a correct column or row segmentation. The exemplary methods are also adaptable to different numbers of slides or negatives in the scan.

The exemplary methods may be implemented as firmware routines resident in the scanner or as part of a software application, such as a scanner driver or image acquisition program. Alternatively, portions of the methods may be implemented as firmware and portions as software, residing on the same or separate devices. The methods of the invention are not limited to a particular implementation or form, but include any implementation that performs the methods as claimed.

It will be apparent to those skilled in the art that the general discussion above does not describe all exceptions or boundary conditions that may be encountered in the process, and that an actual implementation will account for such exceptions or boundary conditions. For example, in some situations, such as a the placement of only a single negative in a column, the method may “default” to the approximate region boundaries identified in step 412, above.

The above is a detailed description of particular embodiments of the invention. It is recognized that departures from the disclosed embodiments may be within the scope of this invention and that obvious modifications will occur to a person skilled in the art. It is the intent of the applicant that the invention include alternative implementations known in the art that perform the same functions as those disclosed. This specification should not be construed to unduly narrow the full scope of protection to which the invention is entitled.

The corresponding structures, materials, acts, and equivalents of all means or step plus function elements in the claims below are intended to include any structure, material, or acts for performing the functions in combination with other claimed elements as specifically claimed.

What is claimed is:

1. A method of identifying scanning regions for scanning multiple photographic slides or negatives arrayed in a grid on a flatbed scanner, comprising:
determining a preliminary region with boundaries for each slide or negative base on an analysis of a preliminary scan at a reduced resolution;
determining, from the preliminary scan, statistical characteristics of the distribution of the slides or negatives;
from the statistical characteristics, determining a mathematical grid, and assigning each slide or negative to a position on the grid; and
from the statistical characteristics, adjusting the boundaries of each preliminary region.

2. The method of identifying scanning regions for scanning multiple photographic slides or negatives arrayed in a grid on a flatbed scanner of claim 1, wherein the statistical characteristics comprise a median spacing of the preliminary regions in at least a first direction.

3. The method of identifying scanning regions for scanning multiple photographic slides or negatives arrayed in a grid on a flatbed scanner of claim 1, wherein the statistical characteristics further comprise a median span of the preliminary regions in a second direction.

4. The method of identifying scanning regions for scanning multiple photographic slides or negatives arrayed in a grid on a flatbed scanner of claim 1, wherein the statistical characteristics comprise a median span of the preliminary regions in at least a first direction.

5. The method of identifying scanning regions for scanning multiple photographic slides or negatives arrayed in a grid on a flatbed scanner of claim 1, wherein the statistical characteristics further comprise a median span of the preliminary regions in a second direction.

6. The method of identifying scanning regions for scanning multiple photographic slides or negatives arrayed in a grid on a flatbed scanner of claim 1, wherein adjusting the boundaries of each preliminary region comprises aligning the boundaries to the grid based on the statistical characteristics.

7. The method of identifying scanning regions for scanning multiple photographic slides or negatives arrayed in a grid on a flatbed scanner of claim 1, further comprising ordering the regions to conform to an ordering represented on a scanning adapter.

8. A method of defining scanning regions for multiple photographic negatives or slides positioned in a scanner with a scanning adapter, the negatives or slides positioned on a scanning bed and distributed in a horizontal direction and a vertical direction, the method comprising:
identifying approximate regions for the slides or negatives;
from the identified approximate regions, determining a horizontal median spacing between any horizontally adjacent regions and a vertical median spacing between any vertically adjacent regions, and a horizontal median span and vertical median span of the regions;
from the horizontal median spacing, the vertical median spacing, the horizontal median span, and the vertical median span, defining a grid and assigning each region to a position on the grid; and
adjusting the boundaries for each region based on at least one of the horizontal median spacing, the vertical median spacing, the horizontal median span, and the vertical median span.

9. The method of defining scanning regions for multiple photographic negatives or slides positioned in a scanner with a scanning adapter of claim 8, wherein identifying approximate regions for the slides or negatives comprises defining and convexing the solid regions known to lay outside and surround the slides or negatives.

10. The method of defining scanning regions for multiple photographic negatives or slides positioned in a scanner with a scanning adapter of claim 8, wherein defining a grid comprises defining default horizontal rows and default vertical columns for the regions.

11. The method of defining scanning regions for multiple photographic negatives or slides positioned in a scanner with a scanning adapter of claim 10, wherein defining default horizontal rows comprises determining whether any portion of a region falls along a same horizontal scan line as any portion of another region.

12. The method of defining scanning regions for multiple photographic negatives or slides positioned in a scanner with a scanning adapter of claim 11, wherein if a default row includes more than two regions and any two regions do not fall along at least one horizontal scan line, the default row is determined to be two rows.

13. The method of defining scanning regions for multiple photographic negatives or slides positioned in a scanner with a scanning adapter of claim 10, wherein defining default vertical columns comprises determining whether any portion of a region falls along a same vertical scan line as any portion of another region.

14. The method of defining scanning regions for multiple photographic negatives or slides positioned in a scanner with a scanning adapter of claim 13, wherein if a default column includes more than two regions and any two regions do not fall along at least one vertical scan line, the default column is determined to be two columns.

15. The method of defining scanning regions for multiple photographic negatives or slides positioned in a scanner with a scanning adapter of claim 8, wherein assigning each region to a position on the grid further comprises determining a mean position in the vertical direction for each region, and determining the closest default row based upon the mean position in the vertical direction for each region.

16. The method of defining scanning regions for multiple photographic negatives or slides positioned in a scanner with a scanning adapter of claim 8, wherein assigning each region to a position on the grid further comprises determining a mean position in the horizontal direction for each region, and determining the closest default column based upon the mean position in the horizontal direction for each region.

17. The method of defining scanning regions for multiple photographic negatives or slides positioned in a scanner with a scanning adapter of claim 8, wherein adjusting the boundaries for each region comprises adjusting the boundaries with respect to the grid.

18. The method of defining scanning regions for multiple photographic negatives or slides positioned in a scanner with a scanning adapter of claim 8, further comprising ordering the regions to conform to the ordering represented on the scanning adapter.

19. The method of defining scanning regions for multiple photographic negatives or slides positioned in a scanner with a scanning adapter of claim 18, wherein the regions being scanned comprise slides, and the ordering represented on the scanning adapter is reading order.

20. The method of defining scanning regions for multiple photographic negatives or slides positioned in a scanner with a scanning adapter of claim 18, wherein the regions being scanned comprise negatives, and the ordering represented on the scanning adapter is columnar order.
